(19) United States
(12) Patent Application Publication
(10) Pub. No.: US 2005/0257779 A1
(43) Pub. Date: Nov. 24, 2005

(54) Multiple speed fuel pump control module

(75) Inventors: James Knight, Ypsilanti, MI (US); Paul A. Crosby, Ann Arbor, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 10/847,723

(22) Filed: May 18, 2004

(51) Int. Cl. F02M 37/04

(52) U.S. Cl. 123/497

(57) ABSTRACT

A system for fuel delivery in an automotive vehicle is provided. The system includes a fuel pump and an electrical control module. The electrical control module receives a control signal from the engine control module indicating a desired fuel pump speed. The electrical control module includes a pulse width modulator and a solid-state switch configured to generate a fuel pump drive signal that varies in duty cycle based on the control signal. The drive signal is provided to the fuel pump effectively controlling the speed of operation of the fuel pump. Based on the speed of fuel pump operation, the fuel pump draws fuel from the fuel tank and provides it to the fuel rail for use in a combustion engine.

### BACKGROUND

1. Field of the Invention

The present invention generally relates to a system for fuel delivery in an automotive application.

2. Description of Related Art

Typically, automotive vehicles have fuel delivery systems implemented with either a purely mechanical or purely electrical control system. The mechanically controlled system utilizes a fuel pump motor that is spinning at its maximum possible speed for a given vehicle battery voltage and the selected fuel rail pressure. The fuel rail pressure is controlled through a pressure regulator that bypasses all unused fuel back into the tank. Although, the mechanical method of fuel delivery is simple and inexpensive, the mechanical method is relatively inefficient with regard to fuel consumption.

The electronically controlled fuel delivery system generally implements a constantly varying voltage to the fuel pump. By varying the fuel pump voltage, the speed of the fuel pump motor is controlled. Varying the speed of the fuel pump motor allows the pump to provide only the required amount of fuel to the fuel rail at the required fuel pressure. Although, the electrical control method is more fuel efficient than the mechanical method, the electrical method is relatively expensive.

Attempts have been made to design hybrid mechanical and electrical systems, to date, no durable and cost effective alternatives have been produced. The most popular hybrid attempt utilizes a dropping resistor that is placed in series with the fuel pump. Two speed operation is accomplished by shorting out the dropping resistor using a mechanical relay that is wired in parallel with the dropping resistor. Therefore, when the relay is configured to short across the dropping resistor, a higher voltage is applied to the motor and the motor operates at a high speed. Conversely, when the relay does not short across the dropping resistor, some of the voltage potential is consumed by the dropping resistor generating a lower motor speed. Utilizing the two speed dropping resistor method does provide multiple pump speeds for a low component cost. However, utilizing the relay to short high levels of current around the dropping resistor may lead to eventual reliability problems.

In view of the above, it is apparent that there exists a need for an improved system and method for fuel delivery.

### SUMMARY

In satisfying the above need, as well as overcoming the enumerated drawbacks and other limitations of the related art, the present invention provides a system for fuel delivery in an automotive vehicle. The system includes a fuel pump, an electrical control module, and a pressure regulator. The electrical control module receives a control signal from the engine control module indicating a desired fuel pump speed. The electrical control module includes a pulse width modulator and a transistor configured to generate a fuel pump drive signal that varies in duty cycle based on the control signal. The drive signal is provided to the fuel pump effectively controlling the speed of operation of the fuel pump. Based on the speed of fuel pump operation, the fuel pump draws fuel from the fuel tank and provides it to the fuel rail for use in a combustion engine. Unused fuel is provided along a return line to the pressure regulator thereby controlling the fuel pressure and returning unused fuel to the fuel tank.

The pulse width modulator defines at least two discreet set points including a predetermined frequency and duty cycle. The pulse width modulator varies the drive signal based on the parameters of one of the discreet set points in response to the control signal. An engine control module generates the control signal based on engine performance characteristics, and engine commands. The engine performance characteristics may include engine volume and engine commands include such commands as engine speed and air intake.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a block diagram of a fuel delivery system in accordance with the principles of the present invention; and

FIG. 2 is a graph of fuel pump control current in relation to fuel consumption.

### DETAILED DESCRIPTION

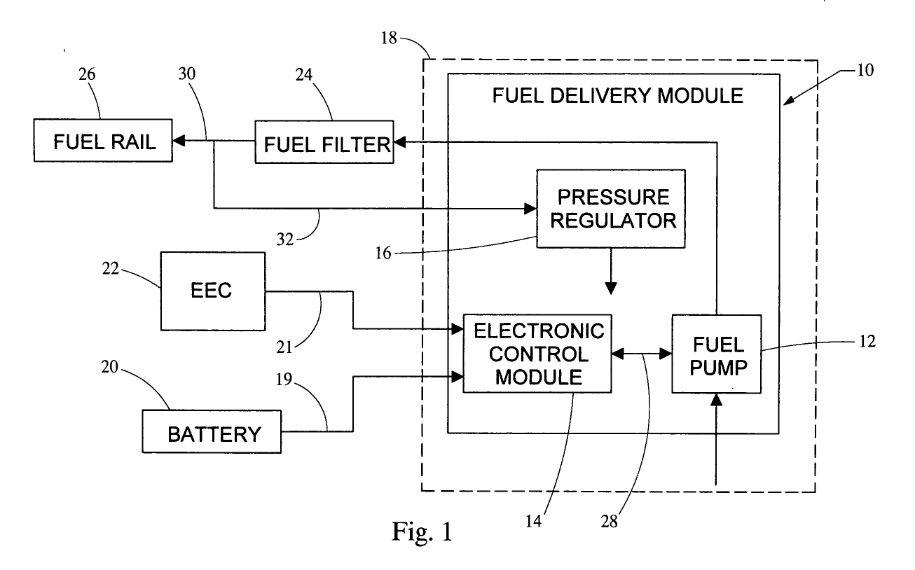

Referring now to FIG. 1, a system embodying the principles of the present invention is illustrated therein and designated at 10. The system 10 includes a fuel pump 12, an electronic control module 14, and a pressure regulator 16. The system 10 draws fuel from the fuel tank 18 and is generally located within the fuel tank 18, although alternate locations are contemplated. A power source 20, typically a battery in automotive applications, provides electrical power along line 19 to the electrical control module 14. An engine control module 22 monitors engine performance commands and engine parameters to determine an appropriate fuel pump speed. Based on fuel pump speed, a control signal 21 is provided from the engine control module 22 to the electrical control module 14 indicating the desired fuel pump speed.

The electronic control module 14 generates a drive signal 28 based on the control signal 21. The fuel pump will operate at a desired speed based on the frequency and duty cycle of the drive signal 28. As the fuel pump 12 operates, it draws fuel from the fuel tank 18 and provides it to the fuel filter 24. The fuel filter 24 removes any contaminants from the fuel before it is provided to the fuel rail 26 along line 30. Any unused fuel is returned to the tank along line 32 to the pressure regulator 16. The pressure regulator 16 is used to control the pressure of the fuel and return any excess fuel into the fuel tank 18.

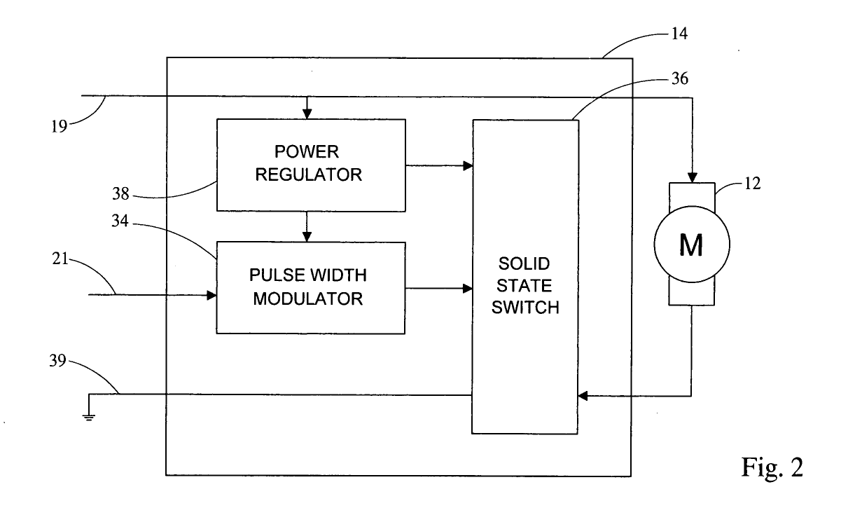

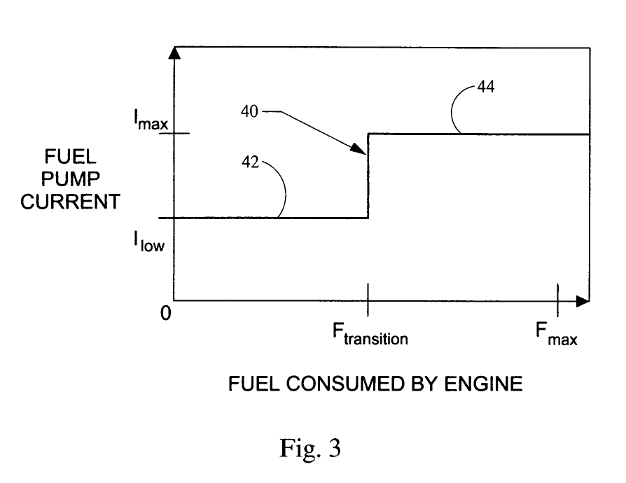

Referring to FIG. 2, the electrical control module 14 includes a pulse width modulator 34 and a solid state switch 36. The electrical control module 14 receives power from the power source 20 along line 19 and distributes the power to the power regulator 38 and the positive terminal of the fuel pump 12. The power regulator 38 provides the required voltage to the pulse width modulator 34 and the solid state switch 36. The control signal 21 is received in the electronic control module 14 by the pulse width modulator 34. Operating at two or more discreet set points, the pulse width modulator 34 is configured to modify the duty cycle of a drive signal 28 in response to the control signal 21. Each set point is defined by a predetermined frequency and duty cycle at which the pulse width modulator 34 is configured to operate. The output of the pulse width modulator 34 is provided to a solid state switch 36 causing the solid state switch 36 to connect the negative side of the fuel pump 12 to electrical ground with a duty cycle corresponding to the output of the pulse width modulator 34. The solid state switch 36 is shown generally as a block although common switching devices, such as, MOSFETs, bipolar transistors, and IGBTS are contemplated. One of the set points may include a duty cycle of 100%, essentially providing constant power to the fuel pump 12 causing it to operate in a full speed mode.

Now referring to FIG. 3, a graph is shown depicting the current provided to the fuel pump 12 in relation to the fuel consumed by the engine. The current signal for a system utilizing two set points is denoted by reference numeral 40. At the first set point, the fuel pump motor operates at 100% duty cycle or full speed at Iₘₐₓ. Using the second set point, the fuel pump operates at a lower duty cycle to generate the current value I_{low}. A predetermined threshold (Fₜᵣₐₙₛᵢₜᵢₒₙ) based on fuel consumption is used to decide which set point to used by the pulse width modulator 34, thereby determining the duty cycle of the drive signal. For fuel consumption less than the predetermined threshold, the fuel pump runs at a low speed mode and consumes I_{low} current as denoted by reference numeral 42. When fuel consumption exceeds the predetermined threshold, the fuel pump runs in the high speed mode and consumes Iₘₐₓ current as denoted by reference numeral 44. This configuration allows the fuel pump to operate at multiple speeds while reducing component cost and eliminating the concerns of component reliability associated with mechanically switching the high amount of current required to operate the fuel pump. Although the implementation shown utilizes two set points, a greater number of set points is contemplated and may readily be used by defining multiple Fₜᵣₐₙₛᵢₜᵢₒₙ thresholds, each threshold corresponding to a set point.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

1. A system for fuel delivery in an automotive vehicle, the system comprising;
a fuel pump; and
an electrical control module in electrical communication with the fuel pump, the electric control module including a solid-state switch and a pulse width modulator, the solid-state switch being in electrical communication with the pulse width modulator and the fuel pump, the pulse width modulator further being configured to generate a drive signal according to a first discreet set point defining a first predetermined duty cycle for the drive signal if the electrical control module determines fuel consumption is above a fuel consumption threshold, and the pulse width modulator being configured to generate the drive signal according to a second discreet set point defining a second predetermined duty cycle for the drive signal if the electrical control module determines the fuel consumption is below the fuel consumption threshold.

2. The system according to claim 1, wherein the pulse width modulator is configured to control the state of the solid state switch.

3. The system according to claim 2, wherein the solid state switch is connected between the fuel pump and an electrical ground, the solid state switch being configured to selectively connect the fuel pimp to the electrical ground based on the drive signal.

4. The system according to claim 1, wherein the first set point has a 100% duty cycle.

5. The system according to claim 1, further comprising an engine control module in communication with the pulse width modulator to select a set point based on engine performance characteristics.

6. The system according to claim 5, wherein the engine performance characteristics include engine volume.

7. The system according to claim 1, further comprising an engine control module in communication with the pulse width modulator to select a set point based on engine commands.

8. The system according to claim 7, wherein engine commands include engine speed.

9. The system according to claim 8, wherein engine commands include air intake.

10. The system according to claim 1, further comprising a pressure regulator in fluid communication with the fuel pump, the pressure regulator being configured to control the pressure of fuel provided by the fuel pump.

11. A method for fuel delivery in an automotive vehicle, the method comprising:
receiving a control signal indicating a desired fuel pump speed;
generating a drive signal using a pulse width modulator to drive the fuel pump at the desired speed, the drive signal being based on a first discreet set point defining a first predetermined duty cycle of the drive signal if fuel consumption is above a fuel consumption threshold, the drive signal being based on a second discreet set point defining a second predetermined duty cycle of the drive signal if the fuel consumption is below the fuel consumption threshold.

12. The method according to claim 11, further comprising controlling the state of a solid-state switch to provide the driving signal to the fuel pump.

13. The method according to claim 11, wherein the first set point has a 100% duty cycle.

14. The method according to claim 11, further comprising modifying the drive signal based on engine performance characteristics.

15. The method according to claim 14, wherein the engine performance characteristics include engine volume.

16. The method according to claim 11, further comprising modifying the drive signal based on engine commands.

17. The method according to claim 161 wherein engine commands include engine speed.

18. The method according to claim 17, whe ein engine commands include air intake.

19. The method according to claim 11, further comprising controlling the pressure of fuel provided by the fuel pump using a pressure regulator.
